(19) United States
(12) Patent Application Publication
(10) Pub. No.: US 2004/0175057 A1
(43) Pub. Date: Sep. 9, 2004

(54) Affine transformation analysis system and method for image matching

(76) Inventors: Thomas Tsao, Potomac, MD (US); Stanley Yuen, Montgomery Village, MD (US)

Correspondence Address: Thomas Tsao, 11901 Cold Stream Dr., Potomac, MD, 20854, US

(21) Appl. No.: 10/377,649

(22) Filed: Mar. 4, 2003

(51) Int. Cl. G06K 9/36; G06F 15/00

(52) U.S. Cl. 382/294; 712/10

(57) ABSTRACT

An affine transformation analysis system and method is provided for matching two images. The novel systolic array image affine transformation analysis system comprising a linear rf-processing means, an affine parameter incremental updating means, and a least square error fitting means is based on a Lie transformation group model of cortical visual motion and stereo processing. Image data is provided to a plurality of component linear rf-processing means each comprising a Gabor receptive field, a dynamical Gabor receptive field, and six Lie germs. The Gabor coefficients of images and affine Lie derivatives are extracted from responses of linear receptive fields, respectively. The differences and affine Lie-derivatives of these Gabor coefficients obtained from each parallel pipelined linear rf-processing components are then input to a least square error fitting means, a systolic array comprising a QR decomposition means and a backward substitution means. The output signal from the least square error fitting means then be used to updating of the affine parameters until the difference signals between the Gabor coefficients from the static and dynamical Gabor receptive fields are substantially reduced.

### BACKGROUND OF THE INVENTION

1. Field of the Invention

The invention relates generally to an image analysis system and method for matching images and; more particularly, to massively parallel and pipelined arrays of processing elements for determining parameters of affine transformations between two images. The invention further relates to an image registration system comprising a plurality of specially constructed pipelined array of computing devices for real-time extraction of Gabor coefficients of windowed images and their affine Lie derivatives, and a system and method for determining the affine transformations among the windowed images over a designated scene spot.

2. Description of the Related Art

Matching optical images taken on same scene surface area has many applications. Matching of two images means calculating from place to place the appropriate geometric transformations that compensate the differences of images. Image matching is an essential part and the hard core of various visual perceptual processes. In biological vision, the depth perception comes after the fusion of binocular images, which naturally matches a scene from a stereo pair of images with disparities. In computer vision, object recognition often requires matching of sensor images to stored templates. In an autonomous guidance system using imaging sensor, target tracking often requires computation of geometric transformations of time-varying imagery over the target area to keep the target being locked on. Navigation of unmanned vehicles often requires registration of the sensor imagery with stored rectified images of landmarks. In photogrammetric applications of aerial photos, precise registration of images is often performed manually using various instruments supplemented with analytical computer schemes.

Matching and registration of images taken from different positions is discussed in a book by Azriel Rosenfeld and Avinash C. Kak entitled “Digital Picture Processing,” Published by Academic Press in 1982. It is believed that two pictures of a scene cannot be registered by applying a simple transformation; rather a transformation must be defined piecewise, based on the positions of corresponding ‘landmarks’ in the two pictures.

In the article entitled “Direct Multi-resolution Estimation of Ego-motion and Structure from Motion,” written by K. J. Hanna, published in: Proceedings of The IEEE Workshop of Visual Motion, New Jersey, Oct. 7-9, pp.156-162, 1991, and the article entitled “Hierarchical Model-based Motion Estimation,” written by J. R. Bergen, P. Anandan, K. J. Hanna, and R. Hindorani, published in: Proceedings of European Conference on Computer Vision, G. Sandini Ed. Springer-Verlag, 1992, a multiple scale scheme going from coarse to fine to compute locally defined geometric transformations of images was taught.

Continuous geometric transformations between image areas are in general nonlinear mappings from one image plane to another image plane. At a place where the nonlinear geometric mappings are differentiable or can be approximately described by a differentiable one, the first order Taylor expansion of the differentiable mapping at the place, a 2-D affine transformation, often provides a good local approximation for said continuous geometric transformations.

Accurate and real-time computation of locally defined image geometric transformations has applications in geological survey, traffic accident investigations, diagnosis and treatment in medicine, robotics, automatic manufacturing, military surveillance, and weapons targeting systems. Current methods in computing local geometric transformations of windowed images is by using general purposed computers through trial and error search of transformation parameters. The method confronts with combinatorial complexity and is difficult to achieve real-time performance.

Special digital computing methods and devices are often tailored to some special algorithms and the required computation to achieve maximum use of the computational resource and capacity. Particularly, massively parallel and pipelined processing elements organized in a system of processing element arrays according to a specific design are often employed to speed up the computation of many image-processing tasks.

To take advantage of a system of massively parallel and pipelined processing elements, which can be built by very large scale integrated (VLSI) circuit technology, the array system and the associated processing method are designed to match and explore the parallelism and sequencing structure inherent to said process algorithm.

In two previously issued U.S. patents granted to Thomas Tsao, U.S. Pat. No. 5,535,302, titled “Method and Apparatus for Determining Image Affine Flow Using Artificial Neural System with Simple Cells and Lie Germs,” and U.S. Pat. No. 5,911,035, titled “Method and Aparatus for Determining Binocular Affine Disparity and Affine Invariant Distance Between Two Image Patterns,” a biologically inspired algorithm for computing affine transformation between windowed images over the same scene spot was disclosed, along with the methods and apparatus for two different application scenarios, one involves computation of infinitesimal affine transformations during continuous visual tracking and motion perception, and the other involves computation of finite affine transformations that requires a dynamical receptive field computational structure.

The two previously issued patents disclosed the analog apparatus and methods directly modeled after the analog biological vision systems of vertebrates. The apparatus and methods disclosed in both of the patents include a Lie transformation group theoretic mathematical model of the dynamical system of biological visual information processing, and the physical means of an analog implementation of the dynamical processing system of visual information.

The Lie transformation group theoretic mathematical model of the dynamical vision system of animals can also be viewed as an algorithmic description of the numeric procedure simulating the dynamical system of the vision process. The analog dynamical systems and their numerical simulations are significantly different in their requirements and performances. They require some very different computational apparatus and methods. The current invention discloses a specially designed digital apparatus and method of computing the affine transformations, namely the first order Taylor expansions of generally nonlinear geometric transformations between images over common scene surface spots, based on essentially the same Lie transformation group theoretic mathematical model of image matching depicted in the previous two patents.

In areas such as telecommunication, multimedia, internet processing, video and image processing, computer vision, etc. the sizes of these computational problems tend to grow in order to guarantee the required performance in the solutions, and the problem must be implemented in real time. The computational problems from these application domains require high performance computers. The algorithms, used by these applications, typically involve highly parallel structures executing a huge number of simple and regular computations, and are well suitable for massively parallel computations. Depending on the nature of the particular application, specially designed, dedicated VLSI processors/chips often provide solutions many orders of magnitudes faster than that of a general purpose processor. Termed as systolic processing element arrays, the processing elements in these arrays for simple computational tasks are pipelined and networked together to accomplish much more sophisticated computation tasks. Due to the fact that the data path often matches communication path, simplified processing unit, and local communication, in some applications, the systolic processing element arrays can bring in up to 40,000 times in area efficiency improvement. Systolic arrays are also energy efficient and are suitable for various computationally intensive applications.

Examples of the application of VLSI bit-level systolic processing element arrays include very high performance scalable digital beamforming processes. Systolic arrays are also designed for low level image processing applications using the algorithms involving contrast enhancement, convolution, edge detection, and simple filtering.

The computational problems involved in vision processes such as object recognition, target tracking, stereo image matching are much more sophisticated and difficult. However, these problems also exhibit essential data parallelism, regularity, and pipelined data dependency. The apparatus and method disclosed in this invention embodies a computing system with a specially designed massively parallel and pipelined processing architecture.

### SUMMARY OF THE INVENTION

The present invention provides a method and apparatus for computing affine transformation between windowed images by using massively parallel and pipelined digital VLSI processing element arrays, and realizes advantages over and overcomes several shortcomings associated with existing approaches. The present invention is based on the algorithm derived from a Lie transformation group theoretic model of cortical processing of visual information and geometric analysis of primates, including affine parameter extraction from two windowed images and adaptive compensation of the image variation via dual affine transformation of the Gabor type receptive fields during the process of measuring the differences of the two images. This Lie transformation group theoretic model based algorithm is a closed form analytical numerical algorithm without feature correspondence. It has advantages over various versions of trial and error methods or feature based method of image matching currently being used in computer vision, in that it is efficient, accurate, and most importantly, exhibits a highly regular computational structure. By hardwiring the highly regular computational structure and the overall algorithm into a system of massively parallel and pipelined processing element arrays, significant reductions in energy consumption, the required areas of VLSI material, and the time required for the computation are to be realized.

Accordingly, it is an object of this invention to provide a method and apparatus for rapidly determining the affine transformation that minimizes the differences between two windowed images, thereby matching these two windowed images with high accuracy.

It is another object of this invention to provide a method and apparatus for determining the affine transformation with a closed form analytical numerical procedure with highly regular components.

It is another object of this invention to explore the regularity in computational structure using massively parallel and pipelined processing element arrays which serve as real time computational means for providing a representation of windowed images by projecting to a set of basis functions modeled after different linear receptive fields of neurons of visual cortex of primates, wherein said representation of windowed imagery includes a set of Gabor coefficients and their affine Lie derivatives.

It is another object of this invention to provide a digital simulation of dynamical receptive fields of neurons via parallel and pipelined processing element arrays serving as a real time computational means for determining weights of the adaptively changed Gabor type receptive fields according to the affine parameters and use them to extract the Gabor coefficients of the windowed imagery accordingly.

It is yet another object of this invention to provide a parallel and pipelined processing element arrays serving as a real time computational means for determining affine parameters through the execution of hardwired codes for computing the solutions based on the least square error criterion.

### BRIEF DESCRIPTION OF THE DRAWINGS

These and other features and advantages of the present invention will be more readily apprehended from the following detailed description when read in connection with the appended drawings, in which:

FIG. 1 is a schematic diagram of the overall architecture of the digital computational system using massively parallel and pipelined processing element arrays according to the algorithm based on a Lie group theoretic model of image geometric transformation computations;

FIG. 2 is a schematic diagram of a processing element array performing a typical computational function of linear analysis on intensity image data;

FIG. 3 is a diagram of a typical static linear receptive field processing element;

FIG. 4 is a diagram of a typical adjustable linear receptive field processing element;

FIG. 5 is a schematic diagram of the QR decomposition part of the least square error (LSE) solution processing element array.

FIG. 6 is a schematic diagram of the backward substitution part of the least square error (LSE) solution processing element array.

### DETAILED DESCRIPTION OF THE AN ILLUSTRATIVE EMBODIMENT

This invention is a digital system built around a dynamical system model of visual pattern matching in the primate's visual cortex during motion perception, binocular stereo fusion, and place recognition. Computing the affine transformations between the corresponding windowed images and determining their matching is the essential part of visual information processing.

A novel method and analog geometric computing devices for computing Gabor coefficients of input imagery, their affine Lie derivatives, and the affine flow in consecutive images are disclosed in U.S. Pat. No. 5,535,302 for image motion. Further, a novel method and analog geometric computing devices for computing the coefficients of input imagery with dynamical Gabor receptive fields, their affine Lie derivatives, and the parameters of the affine transformations between a binocular image pair or between the sensor image and the template are disclosed in U.S. Pat. No. 5,911,035 for stereo fusion and image template matching. The previously disclosed Lie transformation group theoretic computational model is summarized below.

In accordance with the previously disclosed inventions, the intensity image of a visible surface I(x, y) is a square integrable (L²) function: ∫∫I² (x, y)dxdy<∞. Here x and y are horizontal and vertical coordinates of pixels.

The basis for Gabor representation of image data comprises a plurality of pairs of Gabor functions modeling the receptive fields of simple cells, termed Gabor rf-functions, or simply rf-functions. Each said pair comprises a first-view rf-function and a second-view rf-function initially in common: gⁱ, i=1, . . . , n, where n is the total number of the simple cell pairs in the base of Gabor representation. In the preferred embodiment, the receptive field functions of first-view simple cells can be affine transformed and thus are functions with affine parameters, gⁱ(\overline{ρ})=A*(\overline{ρ})∘gⁱ, where A*(\overline{ρ}) is a two dimensional (2D) affine transformation, \overline{ρ}=(ρ₁, . . . , ρ₆) is the parameter vector of the 2D affine transformation. The rf-functions of simple cells are vectors in the dual space of the L² space of the images: Each gⁱ is a linear functionals on L², called a reference vector. Collectively, in the preferred embodiment of current invention the receptive field functions gⁱ, i=1, . . . , n, constitute a static reference frame for second-view images (I₂) and gⁱ(ρ), i=1, . . . , n, constitutes a dynamical reference frame for first-view images (I₁).

The values

γ₂ⁱ=<gⁱ, I₂>, i=1, . . . , n (1)

provide the second-view Gabor coefficients for the windowed images where <gⁱ, I₂> is the Hilbert space inner product of I₂ and gⁱ. The first-view Gabor coefficients is provided in a similar manner via inner product with gⁱ(ρ)

γ₁ⁱ(ρ)=<gⁱ(ρ), I₁>, i=1, . . . , n. (2)

With reference to Equations 1 and 2, \overline{γ}₂=(γ₂¹, . . . , γ₂ⁿ) and \overline{γ}₁(ρ)=(γ₁¹(ρ), . . . , γ₁ⁿ(ρ)) are the second-view and first-view Gabor coefficient vectors of intensity images I₂ and I₁ respectively. In the preferred embodiment, the j-th Lie derivative of the i-th Gabor coefficient γ₁ⁱ of I₁ is

Ωⱼⁱ=<gⁱ,ⱼ,I₁>

where gⁱ,ⱼ=X*ⱼ∘gⁱ is a Lie germ and X*ⱼ is the Hilbert space conjugate of the infinitesimal generator of the j-th 1-parameter Lie transformation subgroup of the 2D affine Lie transformation group A(2, R).

Briefly, a novel method for determining affine transformation between two windowed images in accordance with the previously disclosed inventions using a dynamical system was provided. In addition, adjustable Gabor rf-functions is provided as a numeric means of implementation of said dynamical system.

The geometric transformation between two windowed intensity images I₂ and I₁ is approximately an affine transformation with parameter vector \overline{ρ}:

I₂(x,y)=(A(\overline{ρ})∘I₁)(x,y), (3)

where A(\overline{ρ}) is a 2D affine transformation applied to image I₁ with parameters in a vector notation \overline{ρ}=(ρ₁, . . . , ρ₆):

$$\begin{matrix}( A ( \vec{ρ} ) ∘ {I}_{1} ) ( x , y ) = {I}_{1} ( {x}^{′} , {y}^{′} ) & ( 4 ) \\ and & \\ ( \begin{matrix}{x}^{′} \\ {y}^{′}\end{matrix} ) = A ( \vec{ρ} ) ∘ ( \begin{matrix}x \\ y\end{matrix} ) . & ( 5 )\end{matrix}$$

Projecting both sides of Equation 3 to Gabor basis functions gⁱ, i=1, . . . , n, resulted

<gⁱ, I₂>=<gⁱ, A(\overline{ρ})∘I₁>, (6)

a system of nonlinear equations for affine parameter \overline{ρ}=(ρ₁, . . . , ρ₆). Notice that

<gⁱ,A(\overline{ρ})∘I₁>=<A*(\overline{ρ})∘gⁱ, I₁>,

where A*(\overline{ρ}) is the Hilbert Space conjugate of the affine transformation operator A(\overline{ρ}). Nearby \overline{ρ}=(0,0,0,0,0,0), equation 6 has following linear approximation:

$${γ}_{2}^{i} = {γ}_{1}^{i} + {\sum }_{j = 1}^{6} {ρ}_{j} < {X}_{j}^{*} ∘ {g}^{i} , {I}_{1} >= {γ}_{1}^{i} + {\sum }_{j = 1}^{6} {Ω}_{j}^{i} {ρ}_{j} . \qquad ( 7 )$$

In accordance with the present invention, System of Nonlinear Equations 6 is preferably solved in the least square error (LSE) sense using a dynamical system having an energy function. The dynamical system reaches an equilibrium state where the energy function has a minimum value. In accordance with current invention and with reference to Equation 6, the energy function is chosen to be the square of the length of the difference vector of first-view and second-view Gabor coefficient vectors:

$$E ( \vec{ρ} ) = {\sum }_{i = 1}^{n} {( {γ}_{2}^{i} - {γ}_{1}^{i} ( \vec{ρ} ) )}^{2} .$$

Such a dynamical system can be properly constructed because Ωⱼⁱ, the Lie derivatives of δⁱ(\overline{ρ})=γ₂ⁱ−γ₁ⁱ(\overline{ρ}), can be calculated, and thereby the system of equations 6 and be solved through an iterative process of solving System of Equations 7, using multidimensional Newton's method.

It is understood that other numerical schemes for solving system of non-linear equations also can be used to find LSE solution of System of Equations 6. For example, the multi-dimensional gradient method also can be applied to find LSE solution for System of Equations 6.

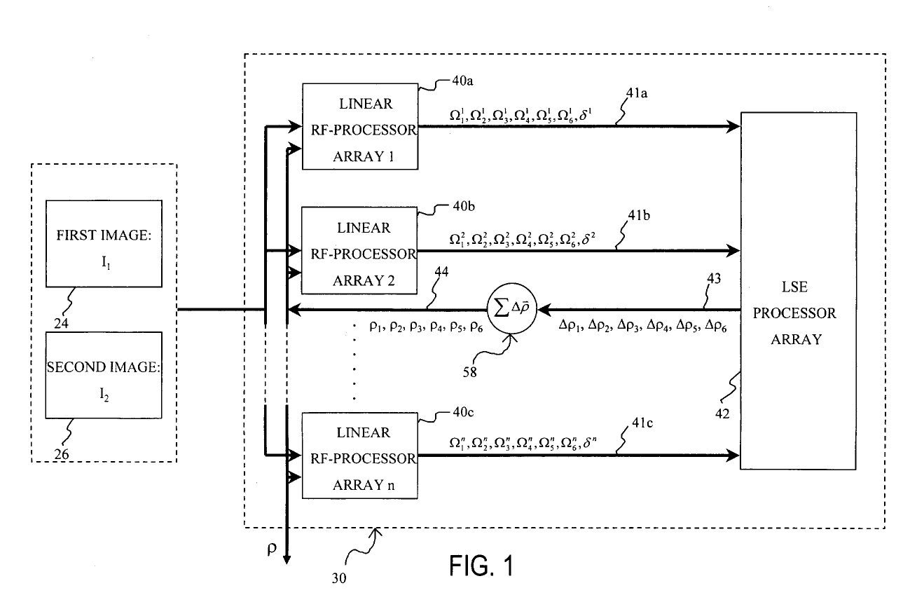

With reference to FIG. 1, in the preferred embodiment, the image affine transformation analysis system using a massively parallel and pipelined array of processing elements, which will later be briefly referred to as systolic array 30, receives data from two images I₁ 24 and I₂ 26 respectively. Said systolic array 30 comprises a system of n linear rf-processing element arrays 40 for computing δⁱ, i=1, . . . , n, the differences of projections of the first image data and the second image data on said rf-functions and Ωⱼⁱ, i=1, . . . , n; j=1, . . . , 6, the projections of the first image data on said Lie germs.

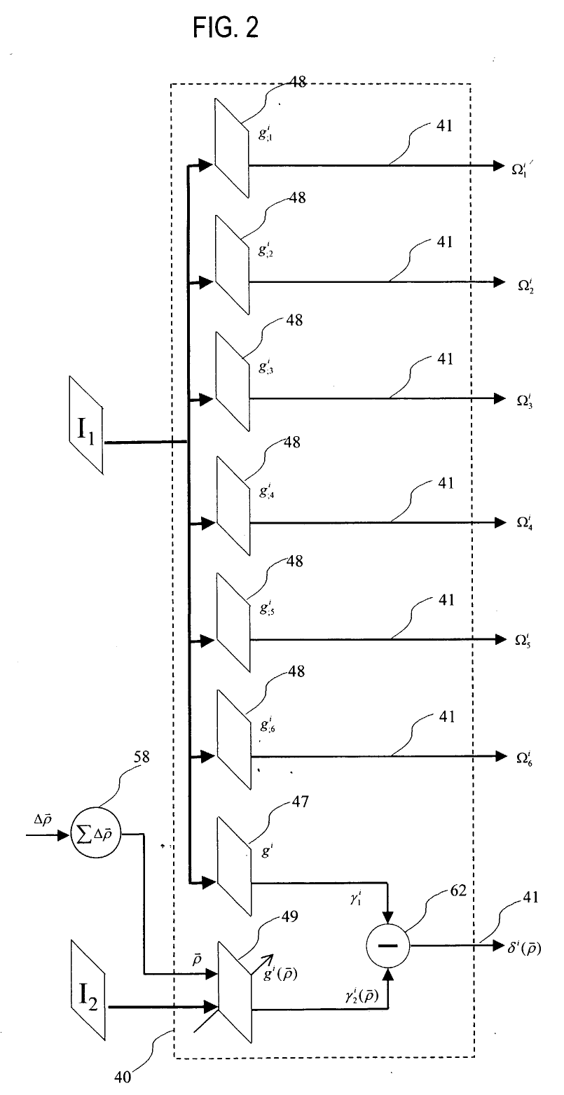

As will be described in further detail below in connection with FIG. 2, within a linear rf-processing element array 40, the Lie derivatives Ωⱼⁱ and difference value δⁱ can be obtained from the output signals of pipelined processing element sub-arrays gⁱⱼ, and the difference between the output signals of the pipelined processing element sub-arrays gⁱ and gⁱ(\overline{ρ}).

In the preferred embodiment of present invention, a set of n Gabor type functions are selected as basis for representing the said windowed images by their Gabor coefficients. The Gabor coefficient vectors \overline{γ}₁=(γ₁¹, . . . , γ₁ⁿ) and \overline{γ}₂=(γ₂¹, . . . , γ₂ⁿ) are also referred as place tokens for the places where the windowed images are taken. Place tokens usually do not represent the images. A place token only captured certain oriented contrasts of intensities in terms of relative strengths to characterize a place on a surface being imaged. Place tokens are invariant in terms of high frequency noise and the cross rf-field DC components caused by illumination changes. The place tokens are not invariant to local geometric transformations of images. The purpose of the current invention is to provide a method and device to computing the geometric transformations of images from the changes of the place tokens.

With continued reference to FIGS. 1, 2, the output signals 41, Ωⱼⁱ, γ₁ⁱ, γ₂ⁱ(\overline{ρ}), δⁱ(\overline{ρ}), j=1, . . . , 6; i=1, . . . n, from three types linear rf-processing element sub-arrays gⁱⱼ 48, gⁱ 47, gⁱ(\overline{ρ}) 49 and a subtraction unit 62, are supplied to LSE processing element array for further resolving the incremental affine transformation parameters Δρ₁, . . . , Δρ₆ 43.

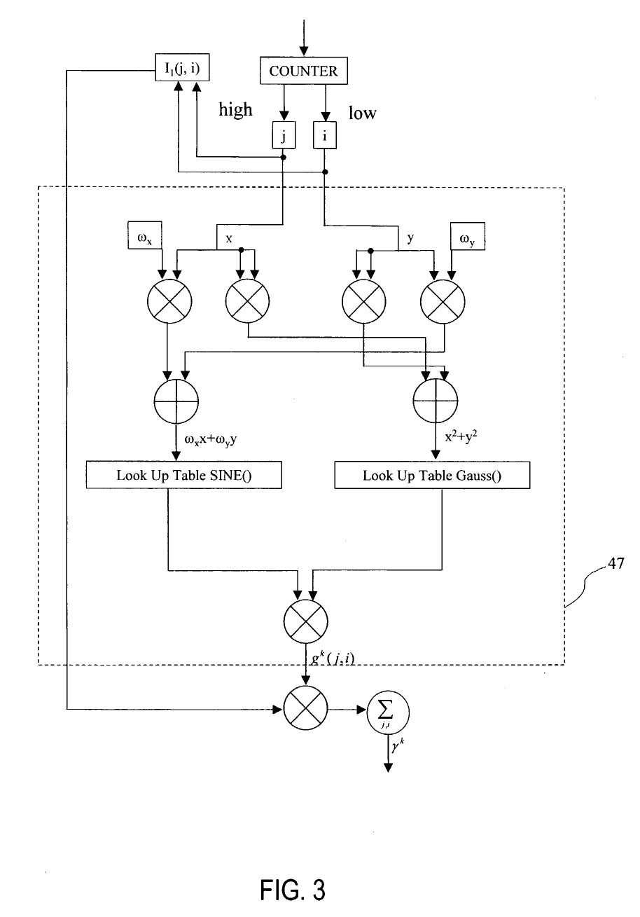

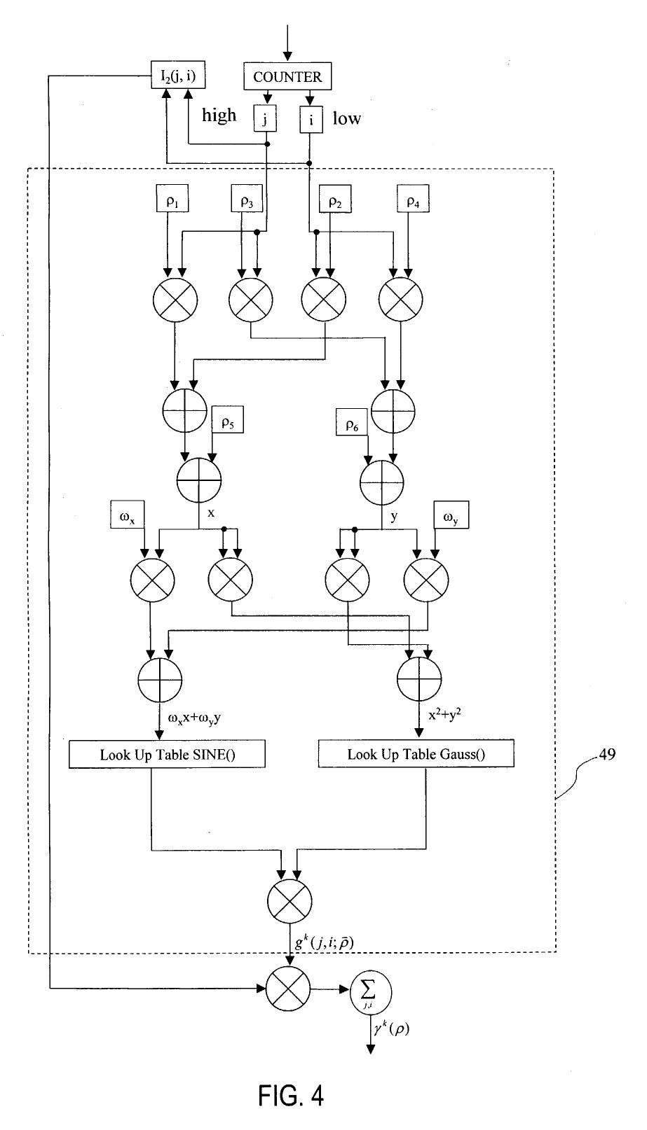

With reference to FIGS. 3, 4, in the preferred embodiment of this invention, the linear systolic arrays 47, 49 are composed of look up tables and several processing elements. Array 48 is constructed using a method similar to that of the array 47. With continued reference to FIG. 1, the output signals from linear rf-processing element arrays 40, δⁱ, i=1, . . . , n, and Ωⱼⁱ, i=1, . . . , n; j=1, . . . , 6, then be fed into the LSE processing element array 42 for further computation of the affine geometric transformation parameters.

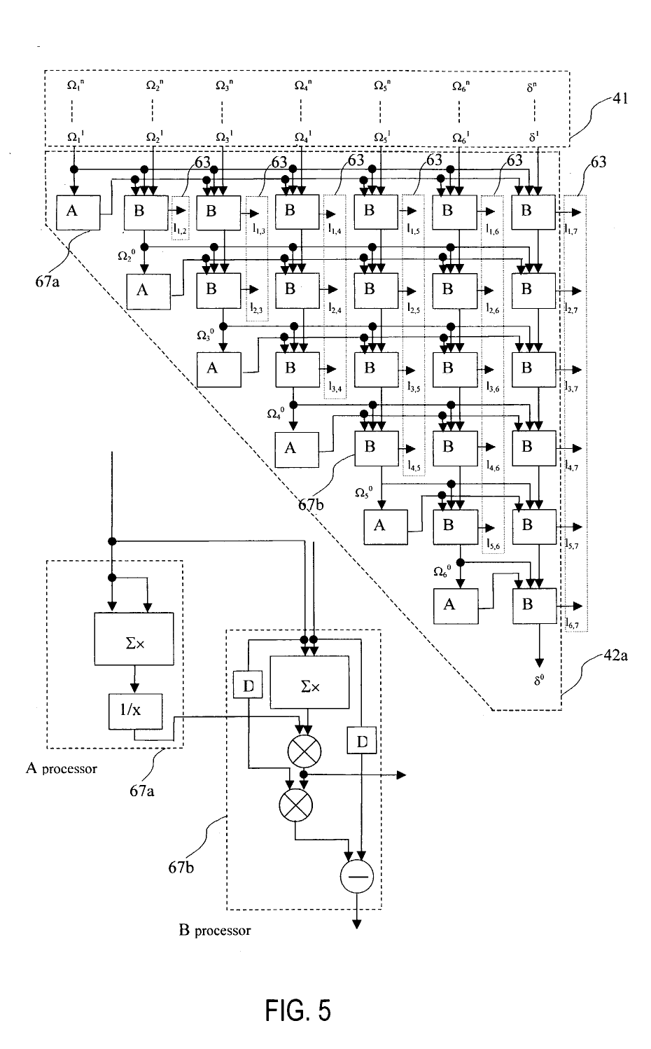

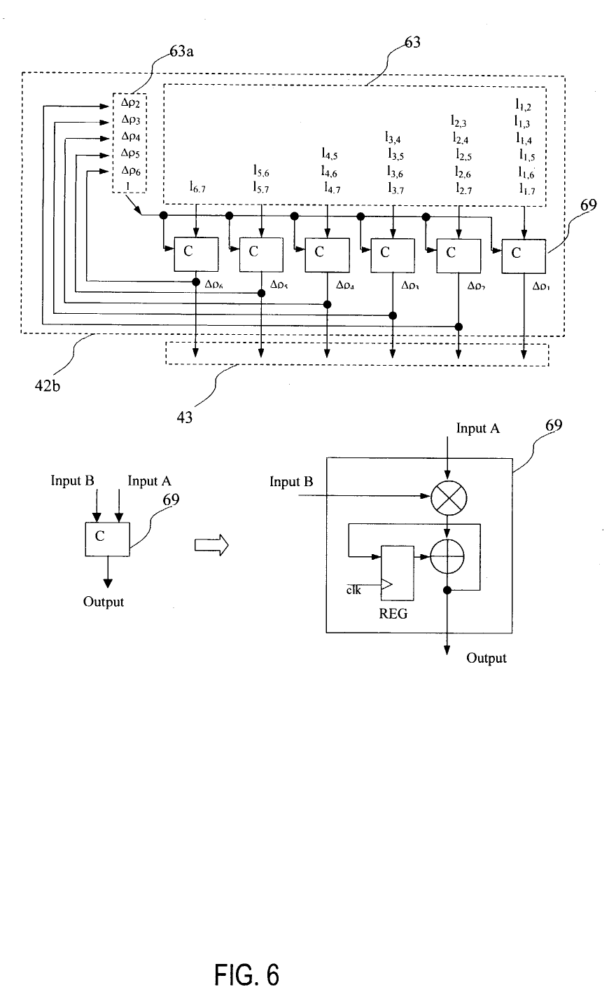

With reference to FIGS. 5, 6, the said LSE processing element array 42 consists of two pipelined sub-arrays, the QR decomposition sub-array 42a and the backward substitution sub-array 42b tightly coupled together. With continuous reference to FIGS. 5, 6, the QR sub-array 42a has input signals 41 from linear rf-processing element arrays and generates output signals of QR decomposition 63, which then be fed into sub-array 42b for back substitution. The sub-array 42b then provide incremental signals Δρ₁, . . . , Δρ₆ 43 of the affine transformations parameters. With further reference to FIG. 1, the incremental signals Δρ₁, . . . , Δρ₆ 43 then input to accumulation unit 58 for updating the affine transformation parameter to obtain improved estimation. In the preferred embodiment of the current invention, the schedule of terminate the updating process and output the signals 44 from the systolic array 30 along with input the image signals 24, 26 is controlled by a device outside of the systolic array 30.

With reference to FIG. 5, in the preferred embodiment of this invention, the first sub-array 42a is constructed with two types process elements: A-type processing elements 67a and B-type processing elements 67b. With reference to FIG. 6, in the preferred embodiment of this invention, the second sub-array 42b is constructed of multiple C-type processing elements 69. Both sub-arrays 42a and 42b are pipelined and properly configured to implement the parallel algorithm of LSE fitting. In particular, the step by step output of increments of affine transformation parameters are accompanied by substitute back 63a in a properly timed manner along with said input signals 63 from QR decomposition sub-array.

Upon convergence, and with reference to Equation 6,

γ₁ⁱ(\overline{ρ})=γ₂ⁱ,

and

δⁱ=γ₂ⁱ−γ₁ⁱ(\overline{ρ})=0.

or sufficiently small.

Although the present invention has been described with reference to a preferred embodiment, the invention is not limited to the details thereof. Various modifications and substitutions will occur to those of ordinary skill in the art, and all such modifications and substitutions are intended to fall within the spirit and scope of the invention as defined in the appended claims.

What is claimed is

1. an affine transformation analysis system for matching two images comprising a linear rf-processing means, an affine parameter incremental updating means, and a least square error fitting means;

2. the affine transformation analysis system of claim 1, wherein said linear rf-processing means comprising a plurality of component linear rf-processing means;

3. the affine transformation analysis system of claim 2, wherein said component linear rf-processing means further comprising one counter means for generating high and low index signals, one static Gabor receptive field means for receiving intensity signals of first one of said two images and providing a Gabor coefficient signal, six Gabor Lie derivative means for receiving intensity signals of first one of said two images and each proving a signal of affine Lie derivative of said Gabor coefficient, one dynamic Gabor receptive field means for receiving the intensity signals of the second of said two images and six affine parameter signals and providing a Gabor coefficient of the second one of said two images, one signal subtraction means for receiving said two Gabor coefficients, one from the static Gabor receptive field means and one from dynamic Gabor receptive field means, and providing the difference signal of the two Gabor coefficients;

4. the affine transformation analysis system of claim 3, wherein said static Gabor receptive field means further comprising a Gabor function evaluation means coupled to said counter means for receiving high and low index signals and providing said Gabor function value, an image input means coupled to said counter means for receiving high and low index signals and providing signal of image intensity, a multiplication means coupled to said Gabor function evaluation means and image input means for receiving signal of said Gabor function value and signal of image intensity and providing a product signal, a signal accumulation means coupled to said multiplication means for receiving said product signals and providing a Gabor coefficient;

5. the affine transformation analysis system of claim 3, wherein said Gabor Lie derivative means further comprising a Gabor Lie germ evaluation means coupled to said counter means for receiving signals of high and low index and providing said Gabor Lie germs value, an image input means coupled to said counter means for receiving signals of high and low index and providing signal of image intensity, a multiplication means coupled to said Gabor Lie germ evaluation means and image input means for receiving signal of value of said Gabor Lie germ and signal of image intensity and providing a product signal, a signal accumulation means coupled to said multiplication means for receiving said product signals of over one image and providing a signal of a Gabor Lie derivative;

6. the affine transformation analysis system of claim 2, wherein said dynamic Gabor receptive field means further comprising a dynamic Gabor function evaluation means coupled to said counter means and affine parameter incremental updating means for receiving signals of high and low index and signals of affine parameters and providing said dynamic Gabor function value, an image input means coupled to said counter means for receiving signals of high and low index and providing signal of image intensity, a multiplication means coupled to said dynamic Gabor function evaluation means and image input means for receiving signal of said dynamical Gabor function value and signal of image intensity and providing a product signal, a signal accumulation means coupled to said multiplication means for receiving said product signals and providing a dynamical Gabor coefficient;

7. the affine transformation analysis system of claim 1, wherein said least square error fitting means further comprising a QR decomposition means coupled to linear rf-processing means for receiving signals of affine Lie derivatives and signals of differences of Gabor coefficients of said two images and providing signals of QR decomposition, and a backward substitution means coupled to said QR decomposition means for receiving QR decomposition signals and providing signals of increments of affine parameters;

8. the affine transformation analysis system of claim 7, wherein said QR decomposition means further comprising a plurality of A-type processing elements each connected to one local input line and two output lines, and a plurality of B-type processing elements each has three input lines and one local output line to other QR processing element and one output line to said backward substitution means, configured and pipelined into an array of processing elements;

9. the affine transformation analysis system of claim 8, wherein said A-type processing elements containing one input line either coupled to linear rf-processing means for receiving signal of a Lie derivative or coupled to the B-type processing element located in previous row of same column of said array of processing elements for receiving signals from the local output line of said B-type processing element, said B-type processing elements containing one input line coupled to linear rf-processing means for receiving a Lie derivative signal when it located in the first row, receiving the local output signal of the B-type processing element located in the previous row in same column, one input line coupled to the A-type processing element of the same row for receiving the output signal of said A-type processing element, one input line coupled to the leftmost B-type processing element of previous row for receiving the local output line signal of said leftmost B-type processing element and providing local output signal and an output signal to backward substitution means;

10. the affine transformation analysis system of claim 8, wherein said backward substitution means further comprising a plurality of C-type processing elements configured and pipelined in a one row array;

11. the affine transformation system of claim 10, wherein each said C-type processing element in said one row array is connected to one input line from a B-type processing element in QR decomposition means, one input line from left side C-type processing elements in said one row array of backward substitution means, and one output line;

12. the affine transformation analysis system of claim 11, wherein said affine parameter incremental updating means coupled to said least square fitting means for receiving signals of affine parameter increments and providing signals of updated affine parameters.

13. in an affine transformation analysis system including a linear rf-processing means for receiving signals of two images and signals of affine parameter vector and providing signals of difference vector of Gabor coefficients of two images and the affine Lie derivatives of said difference vector, an affine parameter incremental updating means for receiving signals of affine parameter increment vector and providing updated affine parameter vector, and a least square error fitting means for receiving signals of said difference vector of Gabor coefficients and providing signals of increment vector of affine parameters, a method for determining the affine transformations between first image and second image described by six parameters comprising the steps of:
setting up a dynamical system with energy function E(\overline{ρ})=|\overline{δ}(\overline{ρ})|², wherein \overline{ρ}. the state vector, is the parameter vector of the affine transformation of said dynamical Gabor receptive field means, and the nonlinear function |\overline{δ}(\overline{ρ})| of \overline{ρ}, a signal extracted by linear rf-processing means, is substantially equivalent to zero when \overline{ρ} is substantially equivalent to said affine transformation between two images; and determining at least one minimum point of said energy function which gives affine parameter vectors;

14. the method of claim 13, wherein said determining step further comprising the step of extracting first and second Gabor coefficient vectors \overline{γ}₁=(γ₁¹, . . . , γ₁ⁿ) and \overline{γ}₂(\overline{ρ})=(γ₂¹(\overline{ρ}), . . . , γ₂ⁿ(\overline{ρ})) of said first image I₁ and second image I₂, respectively, using expressions:
γ₁ⁱ=<gⁱ, I₁>, i=1, . . . , n;
and
γ₂ⁱ(\overline{ρ})=<A*(\overline{ρ})∘gⁱ, I₂>, i=1, . . . , n;
where \overline{ρ}=(ρ₁, . . . , ρ₆) is the parameter vector of the two dimensional affine transformation A*(\overline{ρ}) and n is the total number of Gabor base functions gⁱ employed in said affine transformation analysis system;

15. the method of claim 14, wherein said determining step further comprising the step of computing the difference vector
\overline{δ}(\overline{ρ})=\overline{γ}₁−\overline{γ}₂(\overline{ρ})
of said two Gabor coefficient vectors;

16. the method of claim 13, wherein said determining step comprises the step of computing Lie derivatives of said difference vector \overline{δ}(\overline{ρ}), \overline{Ω}ⱼ=(Ωⱼ¹, . . . , Ωⱼⁿ), j=1, . . . , 6;

17. the method of claim 16, wherein said determining step comprises the step of least square error fitting for over determined linear system of equations for obtaining increment variables Δρⱼ:
$${\sum }_{j = 1}^{6} {Ω}_{j}^{i} Δ {ρ}_{j} + {δ}^{i} = 0 , \qquad i = 1 , … , n$$
where δⁱ=γ₁ⁱ−γ₂ⁱ(\overline{ρ}) is the i-th component of said difference vector;

18. the method of claim 17, wherein said determining step comprises step of adjusting the state vector by an amount of time-dependent state vector increment:
Δ\overline{ρ}:\overline{ρ}←\overline{ρ}+Δ\overline{ρ},

19. the method of claim 18, wherein said determining step further comprises the step of employing a numerical scheme for terminating said dynamical system.
